(19) United States
(12) Patent Application Publication
(10) Pub. No.: US 2016/0050654 A1
(43) Pub. Date: Feb. 18, 2016

(54) CONTROL APPARATUS, COMMUNICATION SYSTEM, CONTROL INFORMATION TRANSMISSION METHOD AND PROGRAM

(71) Applicant: NEC CORPORATION, Tokyo (JP)

(72) Inventor: Yoshihiko KANAUMI, Tokyo (JP)

(21) Appl. No.: 14/777,443

(22) PCT Filed: Mar. 25, 2014
(86) PCT No.: PCT/JP2014/058349

§ 371 Date: Sep. 15, 2015

(30) Foreign Application Priority Data
Mar. 26, 2013 (JP) 2013-063578

(51) Int. Cl. H04W 72/04; H04W 28/06

(52) U.S. Cl. CPC H04W 72/0406; H04W 72/0493; H04W 28/06; H04W 72/0446

(57) ABSTRACT

A control apparatus includes: a control unit that controls a network in its charge, by setting control information in communication node(s) to be controlled; a policy storage unit that holds a policy or policies for selecting, from among the control information, control information to be transmitted to another control apparatus; and a control information exchange unit that transmits, to the other control apparatus, control information selected by referring to the policy.

### TECHNICAL FIELD

### Reference to Related Application

This application is based upon and claims the benefit of the priority of Japanese Patent Application No. 2013-063578 filed on Mar. 26, 2013, the disclosure of which is incorporated herein in its entirety by reference thereto.

The present invention relates to a control apparatus, a communication system, a method of transmitting control information and a program, and in particular to a control apparatus, a communication system, a method of transmitting control information and a program, where communication nodes to be controlled are centrally controlled.

### BACKGROUND

In recent years, technology known as OpenFlow has been proposed (see Non-Patent Literature 1 and 2). In OpenFlow, communication is taken as end-to-end flow, and path control, failure recovery, load balancing, and optimization are performed on a per-flow basis. An OpenFlow switch as specified in Non-Patent Literature 2 is provided with a secure channel for communication with an OpenFlow controller, and operates according to a flow table in which addition or rewriting is instructed by the OpenFlow controller, as appropriate. In the flow table, for each flow there are definitions of sets of match conditions (Match Fields) for collation with packet headers, flow statistical information (Counters), and instructions (Instructions) that define processing content (refer to “5.2 Flow Table” in Non Patent Literature 2).

For example, when an OpenFlow switch receives a packet, a search is made for an entry having a matching condition (refer to “5.3Matching” in Non-Patent Literature 2) that matches header information of the received packet, from the flow table. As a result of the search, in a case where an entry matching the received packet is found, the OpenFlow switch updates the flow statistical information (Counters) and also implements processing content (packet transmission from a specified port, flooding, dropping, and the like) described in an Instructions field of the entry in question, for the received packet. On the other hand, as a result of the search, in a case where an entry matching the received packet is not found, the OpenFlow switch transmits a request for entry setting to the OpenFlow controller via the secure channel, that is, a request to transmit control information for processing the received packet. The OpenFlow switch receives a flow entry determined by processing content and updates the flow table. In this way, the OpenFlow switch performs packet forwarding using entries stored in the flow table as control information.

Patent Literature 1 discloses a configuration of a communication system using the abovementioned OpenFlow, where a plurality of controllers are deployed, and fault-tolerance is improved.

Patent Literature 2 discloses a configuration of a communication system using the abovementioned OpenFlow, where a plurality of controllers give and receive path information.

Patent Literature 3 discloses a configuration of a communication system using the abovementioned OpenFlow, where, among a plurality of controllers, an operational type controller and a standby type controller are synchronized with regard to a flow entry setting state for nodes (refer to FIGS. 18 and 19, for example).

### CITATION LIST

### Patent Literature

### [PTL 1]

Japanese Patent Kokai Publication No. JP2011-160363A

### [PTL 2]

International Publication No. WO2011/083780

### [PTL 3]

International Publication No. WO2012/049807

### Non Patent Literature

[NPL 1] Nick McKeown and seven others, “OpenFlow: Enabling Innovation in Campus Networks”, [online], [Search performed on Mar. 18, 2013], Internet <URL: http://www.openflow.org/documents/openflow-wp-latest.pdf>
[NPL 2] “OpenFlow Switch Specification” Version 1.3.1 (Wire Protocol 0x04), [online], [Search performed on Mar. 18, 2013], <Internet URL: https://www.opennetworking.org/images/stories/downloads/specification/openflow-spec-v1.3.1.pdf>

### SUMMARY

### Technical Problem

The following analysis is given according to the present invention. A configuration has been disclosed in which a plurality of controllers are deployed, as in the abovementioned Patent Literature 1 to 3. However, the configuration of Patent Literature 1 is equivalent to “6.3.4 Multiple Controllers” of Non-Patent Literature 2, and information exchange among controllers does not take place.

A controller of Patent Literature 2 stops at distributing calculated path information, with respect to other controllers. For example, the controller of Patent Literature 2 does not perform information exchange, such as what type of flow entry has been created, in accordance with the path in question.

The controller of Patent Literature 3 synchronizes flow entry setting state with a standby type controller, and requests complete synchronization of content thereof.

It is an object of the present invention to provide a control apparatus, a communication system, a method of transmitting control information, and a program, that can contribute to improving user convenience by sharing information among a plurality of control apparatuses deployed in a centrally controlled network.

### Solution to Problem

According to a first aspect there is provided a control apparatus comprising: a control unit that controls a network in its charge, by setting control information in communication node(s) to be controlled; a policy storage unit that holds a policy or policies for selecting, from among the control information, control information to be transmitted to another control apparatus; and a control information exchange unit that transmits, to the other control apparatus, control information selected by referring to the policy.

According to a second aspect there is provided a communication system comprising: a first control apparatus that comprises: a control unit that controls a network in its charge, by setting control information in communication node(s) to be controlled, a policy storage unit that holds a policy for selecting, from among the control information, control information to be transmitted to a second control apparatus, and a control information exchange unit that transmits, to the second control apparatus, control information selected by referring to the policy; and a second control apparatus that creates control information to be set in communication node(s) to be controlled, by using control information received from the first control apparatus.

According to a third aspect there is provided a method of transmitting control information, wherein a control apparatus comprising a control unit that controls a network in its charge, by setting control information in communication node(s) to be controlled, and a policy storage unit that holds a policy for selecting, among the control information, control information to be transmitted to another control apparatus, performs transmitting control information, the method comprising: a step of selecting control information to be transmitted to the other control apparatus by referring to the policy, and a step of transmitting, to the other control apparatus, the selected control information. This method is associated with a particular mechanism, which is a control apparatus that controls communication nodes.

According to a fourth aspect there is provided a program executed on a computer comprising a control unit that controls a network in its charge, by setting control information in communication node(s) to be controlled, and a policy storage unit that holds a policy for selecting, among the control information, control information to be transmitted to another control apparatus, the program executing a process of selecting control information to be transmitted to the other control apparatus by referring to the policy, and a process of transmitting, to the other control apparatus, the selected control information. It is to be noted that this program may be recorded on a computer-readable (non-transient) storage medium. That is, the present invention may be embodied as a computer program product.

### Advantageous Effects of Invention

According to the present invention, it is possible to contribute to improving user convenience by sharing information among a plurality of control apparatuses deployed in a centrally controlled network.

### BRIEF DESCRIPTION OF THE DRAWINGS

FIG. 1 is a diagram showing a configuration of an exemplary embodiment of the present invention.

FIG. 2 is a diagram showing a configuration of a communication system in a first exemplary embodiment of the present invention.

FIG. 3 is a block diagram showing a configuration of a control apparatus in the first exemplary embodiment of the invention.

FIG. 4 is a diagram showing an example of control information held by the control apparatus in the first exemplary embodiment of the invention.

FIG. 5 is a diagram showing an example of a transmission policy held by the control apparatus in the first exemplary embodiment of the invention.

FIG. 6 is a diagram showing an example of a reception policy held by the control apparatus in the first exemplary embodiment of the invention.

FIG. 7 is a sequence diagram representing operations of the control apparatus in the first exemplary embodiment of the invention.

FIG. 8 is a diagram for describing operations of the control apparatus in the first exemplary embodiment of the invention.

### DESCRIPTION OF EMBODIMENTS

First, a description is given of an outline of exemplary embodiments of the present invention, making reference to the drawings. It is to be noted that reference symbols in the drawings attached to this outline are added to respective elements for convenience, as examples in order to aid understanding, and are not intended to limit the present invention to modes illustrated in the drawings.

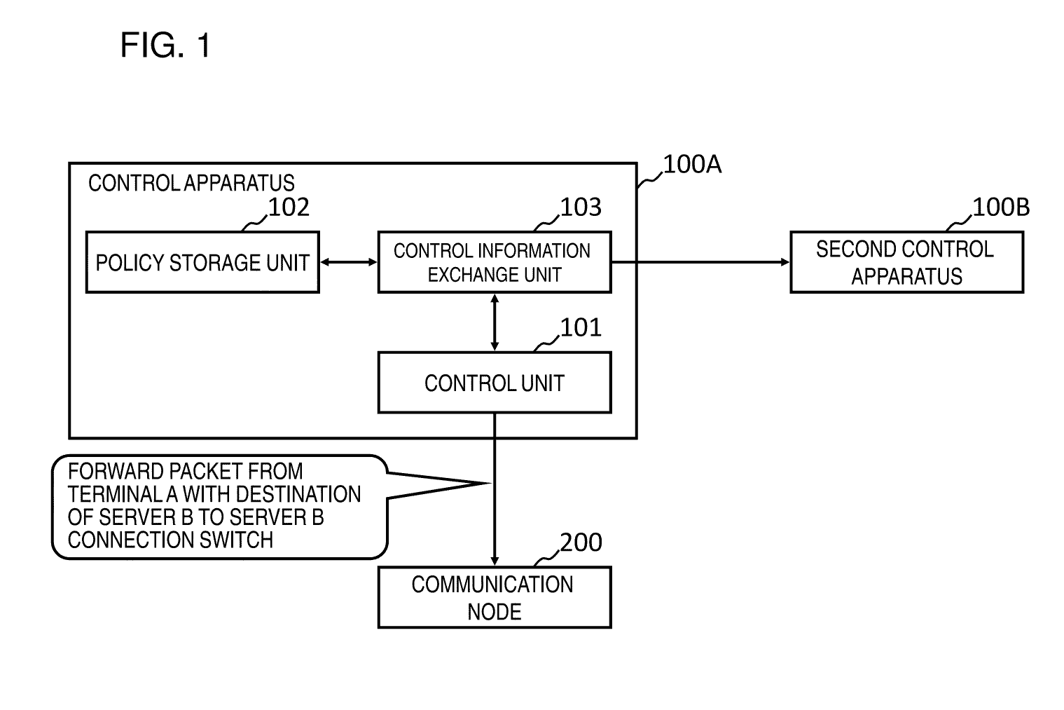

The present invention, in an exemplary embodiment thereof as shown in FIG. 1, may be implemented as a control apparatus provided with: a control unit 101 that controls a network in its charge, by setting control information in communication node(s) to be controlled; a policy storage unit 102 that holds a policy or policies for selecting, from among the control information, control information to be transmitted to another control apparatus; and a control information exchange unit 103 that transmits, to the other control apparatus, control information selected by referring to the policy.

For example, as shown in the balloon in FIG. 1, the control apparatus 100A sets control information of “forward packets from terminal A with destination of server B to a server B connection switch”, for a communication node 200 under its control. At this time, if the policy storage unit 102 stores a policy to transmit control information generated by communication between terminal and server, to a second control apparatus 100B, the control information exchange unit 103 transmits the aforementioned control information to the control apparatus 100B.

The second control apparatus 100B can obtain information that server B is connected to a network under the control of the control apparatus 100A or is at a deliverable location, and that communication between terminal A and server B is permitted, from the control information “packets from terminal A with destination of server B are to be forwarded to a server B connection switch”. Here, for example, in a case where terminal A is separated from the network controlled by the control apparatus 100A and is connected to a network controlled by the second control apparatus 100B, the second control apparatus 100B can use control information sent from the abovementioned control apparatus 100A to create control information for processing packets from terminal A.

It is to be noted that the policy set in the policy storage unit 102 is not limited to the example described above. For example, a filer may be applied according to transmission source (terminal) or destination, or a filer may be applied according to communication type. Or, rather than transmitting control information in order to permit communication, usage is also possible whereby control information directing that packet(s) be dropped is sent, and information of a transmission source attempting unauthorized access is shared.

### First Exemplary Embodiment

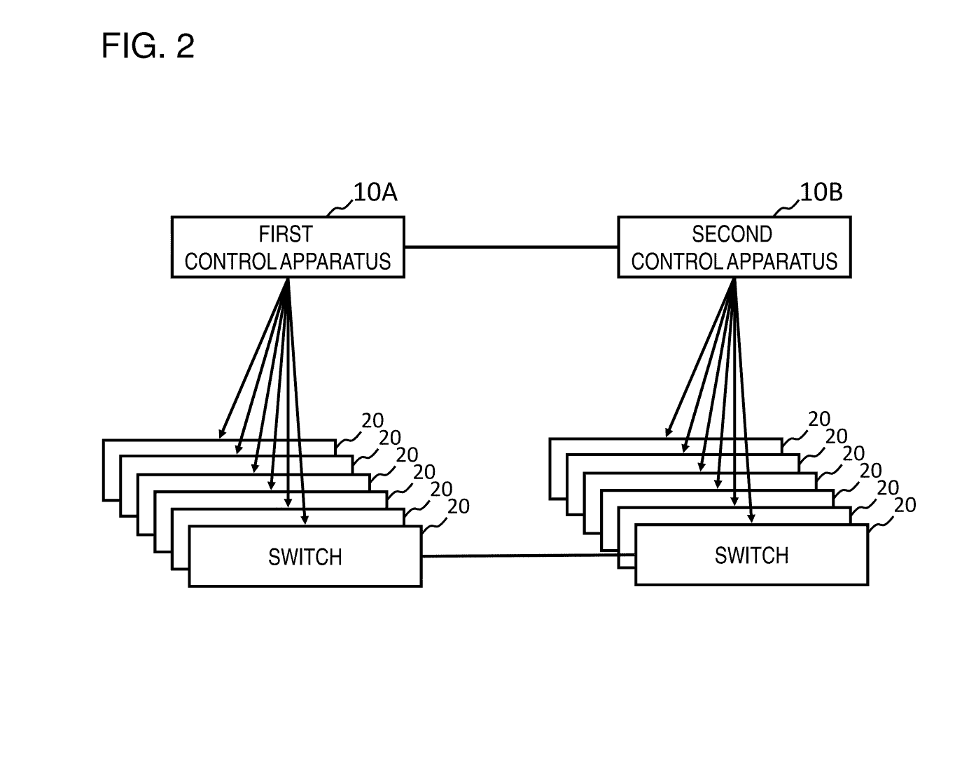

Next, a detailed description is given concerning a first exemplary embodiment of the present invention, making reference to the drawings. FIG. 2 is a diagram showing a configuration of a communication system in the first exemplary embodiment of the present invention. Referring to FIG. 2, a configuration is shown connecting a first control apparatus 10A that controls switches 20 which are to be controlled, and a second control apparatus 10B that controls switches 20 which are to be controlled.

The first control apparatus 10A and the second control apparatus 10B control a switch 20 by setting control information in the switch via respective control channels. An OpenFlow controller and an OpenFlow switch (including a terminal provided with OpenFlow switch functionality or the like) of Non-Patent Literature 1 and 2 may be cited as such a control apparatus and switch. Clearly, other switches and control apparatuses for a centrally controlled network are also possible.

In the example of FIG. 2, switches 20 to be controlled by the first control apparatus 10A and switches 20 to be controlled by the second control apparatus 10B are shown separately, but some portion or the whole thereof may be duplicates. In this case, a switch that receives a setting for control information from 2 control apparatuses may perform an operation such as accepting the earliest received control information, as in “6.3.4 Multiple Controllers” of Non-Patent Literature 2 or in Patent Literature 1.

In the example of FIG. 2, 2 control apparatuses are shown, but it is also possible to have 3 or more control apparatuses. In such a case, it is possible to set a policy as appropriate, and to make a difference in control information sent to respective control apparatuses.

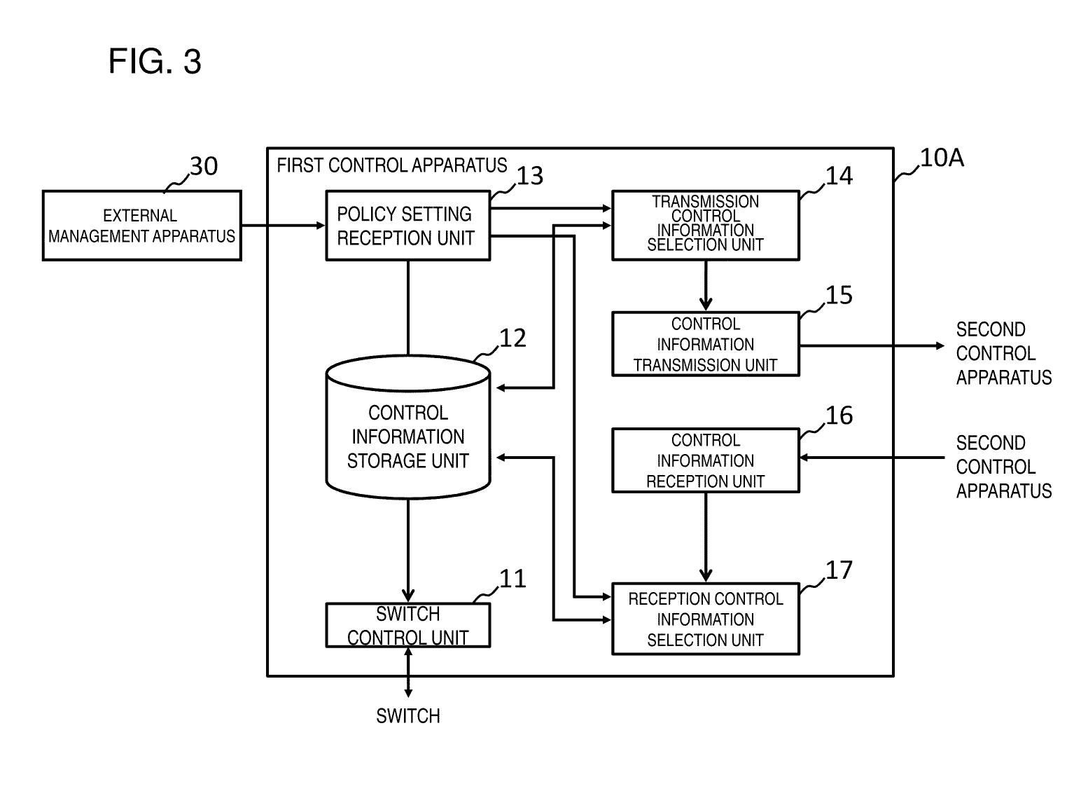

FIG. 3 is a block diagram showing a configuration of the first control apparatus 10A in the first exemplary embodiment of the invention. Referring to FIG. 3, the configuration shown is provided with: a switch control unit 11, a control information storage unit 12, a policy setting reception unit 13, a transmission control information selection unit 14, a control information transmission unit 15, a control information reception unit 16, and a reception control information selection unit 17.

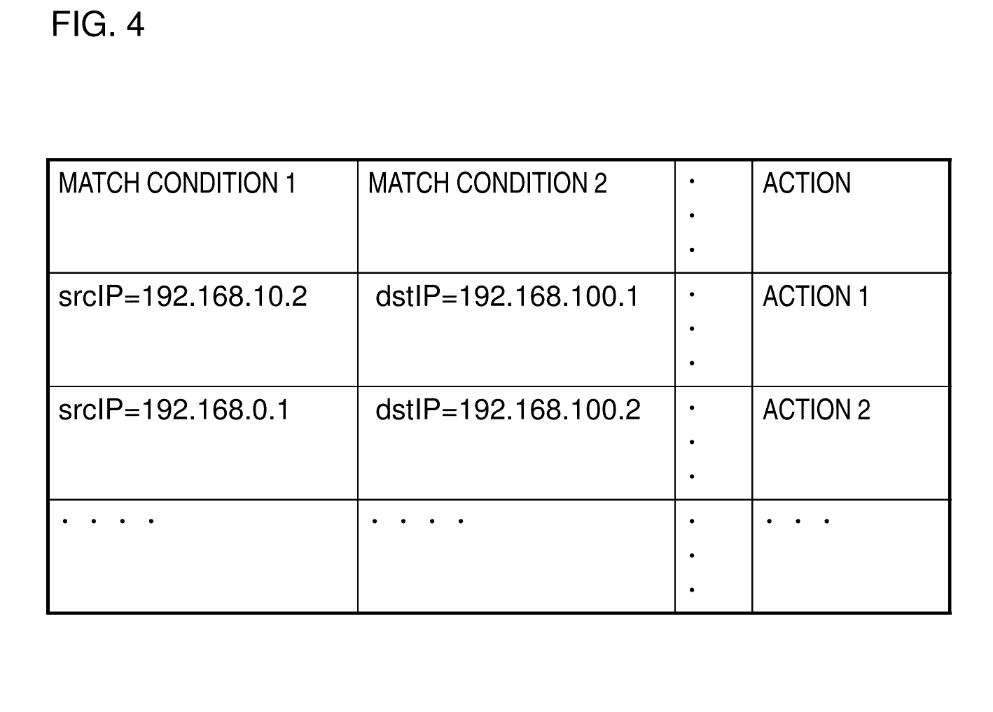

The switch control unit 11 controls a switch by setting control information as shown in FIG. 4, in a switch 20. Match conditions 1 and 2 in FIG. 4 are fields indicating content to match a header or the like of a received packet. An action field is a field for setting processing content (forwarding from a particular port, header rewriting, packet dropping, and the like) to be applied to packets that conform to a match condition. For example, on receiving a packet for which the transmission source IP address is 192.168.10.2 and destination IP address is 192.168.100.1, the switch 20 where the control information of FIG. 4 is set applies the content of “action 1” shown in the action field thereof, to the packet.

It is to be noted that with regard to timing at which the control information is set in the switch 20, a case may be cited where a request (for example, a Packet-In message of Non-Patent Literature 2) is received from the switch 20, or a case where a change in network topology is detected by the control apparatus 10A and an existing packet forwarding path is changed.

The control information storage unit 12 is configured by a database or the like, associating the control information set in the switch 20 and the ID of a switch for setting, and stores this information.

The policy setting reception unit 13 receives a policy for selecting control information to be transmitted to another control apparatus, from a network manager via an external management apparatus 30 and transmits to the transmission control information selection unit 14. The policy setting reception unit 13 of the present exemplary embodiment receives a policy for selecting, among control information received from another control apparatus, control information to be stored in the control information storage unit 12, and transmits to the reception control information selection unit 17.

The transmission control information selection unit 14 refers to a policy sent from the policy setting reception unit 13, and selects control information to be transmitted to another control apparatus, from among control information stored in the control information storage unit 12.

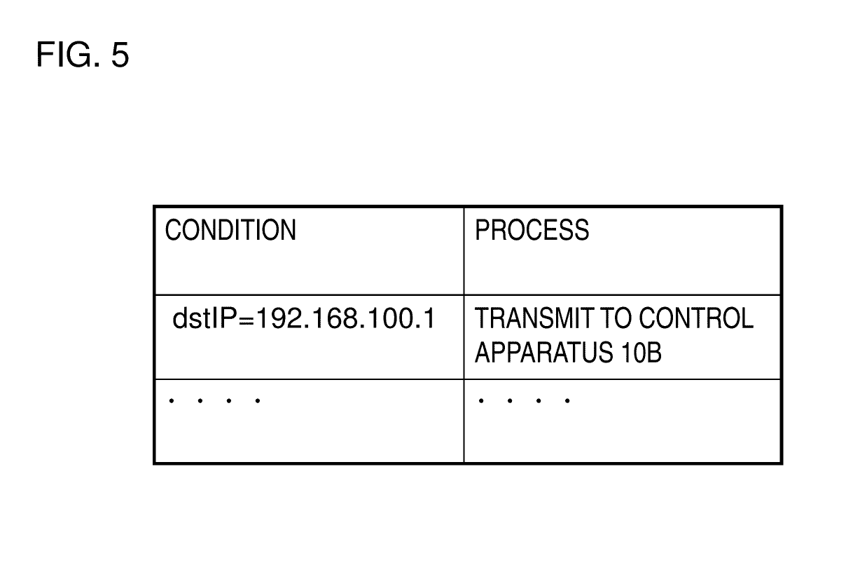

FIG. 5 is a diagram showing an example of a transmission policy for selecting control information to be transmitted to another control apparatus. For example, when the policy shown in FIG. 5 is given, the transmission control information selection unit 14 finds an entry in which the destination IP address is 192.168.100.1 from among the control information stored in the control information storage unit 12, and transmits to the second control apparatus 10B. It is to be noted that as another policy it is also possible to define a range for retrieving control information stored in the control information storage unit 12 (information added/modified within a prescribed past time period is transmitted), and transmission timing (when the number of control information items modified reaches a prescribed number, each prescribed time period). It is also possible to generate a policy not only for the control information but also to add inter-switch topology information or fault history information comprehended by a control apparatus to targets for transmission.

The control information transmission unit 15 transmits control information selected by the transmission control information selection unit 14 to a designated control apparatus.

On receiving control information from another control apparatus, the control information reception unit 16 transmits the information to the reception control information selection unit 17.

The reception control information selection unit 17 refers to a policy sent from the policy setting reception unit 13 to determine whether to store the control information sent from the control information reception unit 16, in the control information storage unit 12, or to discard without storing.

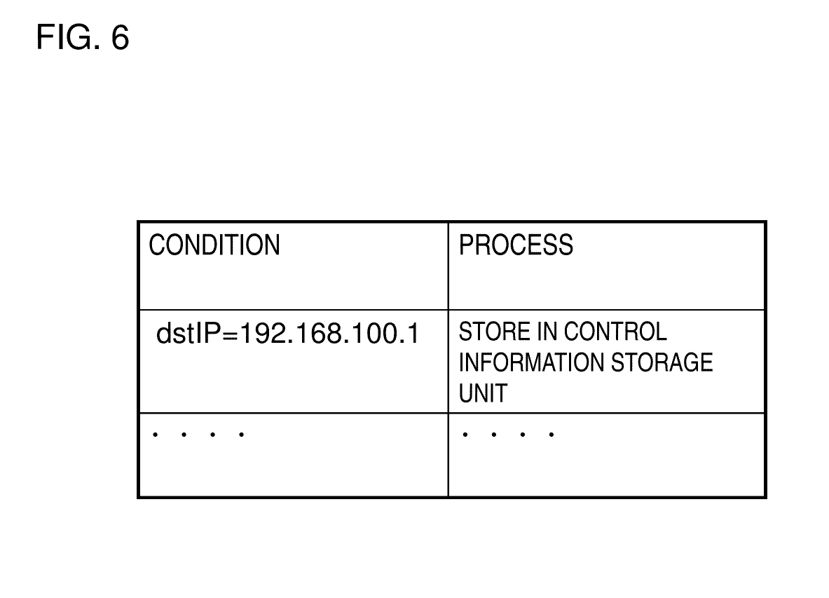

FIG. 6 is a diagram showing an example of a reception policy for determining whether or not control information received from another control apparatus is recorded in the control information storage unit 12. For example, in a case where the policy shown in FIG. 6 is given, the reception control information selection unit 14 performs an operation to store the control information that the destination IP address is 192.168.100.1, in the control information storage unit 12. It is to be noted that, as another policy, it is possible to define the transmission source (control apparatus) of received control information, or control information type, or the like. By so doing, it is possible to improve the quality of transmitted and received control information.

It is also possible to generate a policy not only for the control information but also to add inter-switch topology information or fault history information comprehended by another control apparatus, to targets for reception. By so doing, it is possible to communicate the state of the network on the transmitting side, which is difficult to determine with control information only.

Note that the abovementioned control information transmission unit 15 and the control information reception unit 16 can use another control apparatus and, as a protocol for exchange of control information, a Border Gateway Protocol Version 4 (referred to as “BGP4” below). In this case, it is possible to use message types of control information addition, updating, and keep-alive, in a BGP4 header type field. With regard to transmission of control information, by storing control information that is to be transmitted in variable length fields of these messages (optional parameter field of Open message, or respective variable length fields of Update message), it is possible to exchange control information in a similar procedure to the exchange of path information in BGP4. Clearly, it is also possible to extend and use other protocols such as HTTP (Hypertext Transfer Protocol), HTTPS (Hypertext Transfer Protocol over Secure Socket Layer), and the like.

A description has been given above concerning a configuration of the first control apparatus 10A, but the second control apparatus 10B can also have the same configuration. Since, according to operation policy, a control apparatus that does not transmit control information can be envisaged, in such a case the transmission control information selection unit 14 and the control information transmission unit 15 may be omitted from the configuration shown in FIG. 3.

It is to be noted that the respective parts (processing means) of the first control apparatus 10A shown in FIG. 3 may be implemented by a computer program that executes the abovementioned respective processing on a computer configuring the first control apparatus 10A, using hardware thereof.

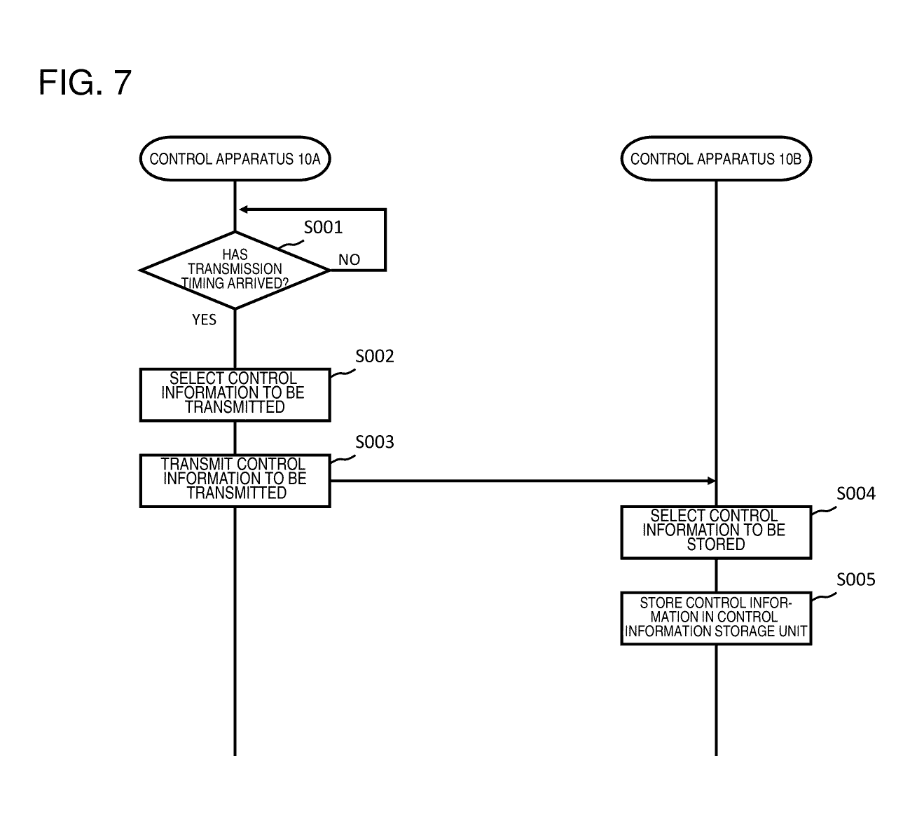

Next, a detailed description is given concerning operations of the present exemplary embodiment, making reference to the drawings. FIG. 7 is a sequence diagram representing operations of the control apparatus in the first exemplary embodiment of the invention. Referring to FIG. 7, the first control apparatus 10A confirms whether or not timing for transmitting control information has arrived, in accordance with the expiry of a prescribed time-period or a condition determined by transmission policy (step S001).

On confirming that timing for transmitting control information has arrived (YES in step S001), the first control apparatus 10A refers to a transmission policy set in advance and selects control information to be transmitted to the control apparatus 10B (step S002).

Next, the first control apparatus 10A transmits the selected control information to the second control apparatus 10B (step S003).

On receiving control information from the first control apparatus 10A, the control apparatus 10B refers to a reception policy set in advance, and selects control information to be stored in a control information storage unit on its own side (step S004).

Next, the second control apparatus 10B stores the selected control information in the control information storage unit on its own side (step S005).

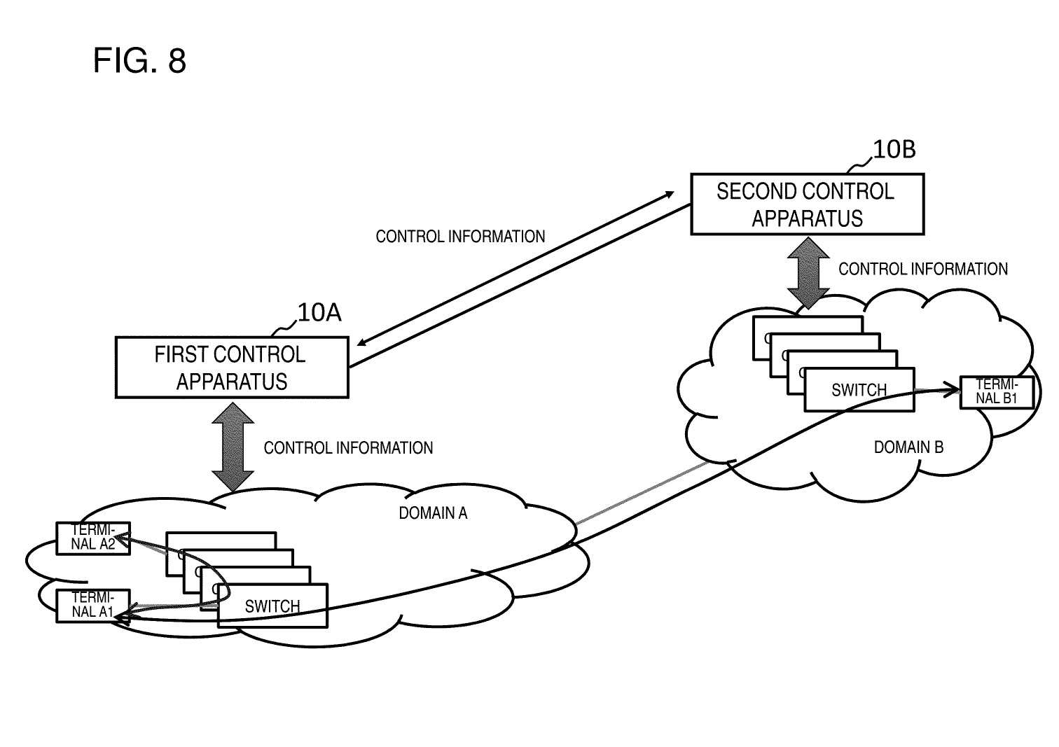

As described above, exchange of control information is performed between the first control apparatus 10A and the second control apparatus 10B. Thus, as shown in FIG. 8 for example, the fact that terminal A1 and terminal A2 are present in domain A which is controlled by the first control apparatus 10A, and terminal B1 is present in domain B which is controlled by the second control apparatus 10B, can be shared by the 2 control apparatuses.

Assuming that the information exchange is performed as above, by the first control apparatus 10A setting control information to implement communication from terminal A1 with destination of terminal B1 in domain A, and the second control apparatus 10B setting control information to implement communication from terminal A1 with destination of terminal B1 in domain B, for example, it is possible to implement communication between terminal A1 and terminal B1. It is to be noted that the second control apparatus 10B can be aware that control information is set to implement communication from terminal A1 with destination of B1 in domain A, based on control information sent from the first control apparatus 10A.

The second control apparatus 10B can generate control information to implement communication from terminal A1 with destination of terminal B1, in a switch in domain B, and when making a setting, can use transmission source information of the control information sent from the first control apparatus 10A, and output switch information with regard to domain B.

A description has been given above of respective exemplary embodiments of the present invention, but the present invention is not limited to the abovementioned exemplary embodiments, and modifications, substitutions and adjustments may be added within a scope that does not depart from fundamental technical concepts of the invention. For example, network configurations and element configurations shown in the respective drawings are examples in order to aid understanding of the invention, and are not intended to limit the invention to configurations illustrated in the drawings.

For example, in the abovementioned exemplary embodiment a description was given where a control apparatus is provided with the control information transmission unit 15 and the control information reception unit 16, but it is also possible to provide a control information exchange unit integrating the two.

Finally, preferred modes of the present invention are summarized.

### [First Mode]

(Refer to the control apparatus according to the first aspect described above.)

### [Second Mode]

The control apparatus according to the first mode, wherein a communication node that is to be controlled by the apparatus itself and a communication node that is to be controlled by the other control apparatus are connected, and a selection is made of control information to implement communication between equipment connected to the communication node that is to be controlled by the apparatus itself, in accordance with the policy.

### [Third Mode]

The control apparatus according to the first or second mode, wherein a communication node that is to be controlled by the apparatus itself and a communication node that is to be controlled by the other control apparatus are connected, and a selection is made of control information to drop packet(s) from equipment connected to the communication node that is to be controlled by the apparatus itself, in accordance with the policy.

### [Fourth Mode]

The control apparatus according to any one of the first to third modes, further including a control information storage unit that stores the control information, wherein the control information exchange unit selects control information conforming to the policy from the control information storage unit at prescribed time intervals, and transmits to the other control apparatus.

### [Fifth Mode]

The control apparatus according to the fourth mode, wherein, with control information recorded in the control information storage unit in a past prescribed time-period as a target, among the control information stored in the control information storage unit, the control information exchange unit selects control information to be transmitted to the other control apparatus.

### [Sixth Mode]

The control apparatus according to the fourth or fifth mode, wherein the policy storage unit holds a reception policy for selecting control information to be stored in the control information storage unit among control information received from the other control apparatus, and the control information exchange unit refers to the reception policy to select control information received from the other control apparatus to be stored in the control information storage unit.

### [Seventh Mode]

The control apparatus according to any one of the first to sixth modes, wherein a Border Gateway Protocol Version 4 (BGP4) is used as a protocol for transmitting the control information.

### [Eighth Mode]

(Refer to the communication system according to the second aspect described above.)

### [Ninth Mode]

(Refer to the method of transmitting control information according to the third aspect described above.)

### [Tenth Mode]

(Refer to the program according to the fourth aspect described above.) It is to be noted that the eighth to tenth modes described above may be expanded with regard to the second to seventh modes, similar to the first mode.

It is to be noted that the various disclosures of the abovementioned Patent Literature and Non-Patent Literature are incorporated herein by reference thereto. Modifications and adjustments of exemplary embodiments and examples may be made within the bounds of the entire disclosure (including the scope of the claims) of the present invention, and also based on fundamental technological concepts thereof. Various combinations and selections of various disclosed elements (including respective elements of the respective claims, respective elements of the respective exemplary embodiments and examples, respective elements of the respective drawings, and the like) are possible within the scope of the entire disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular description thereof.

### REFERENCE SIGNS LIST

10A, 10B, 100A, 100B control apparatus
11 switch control unit
12 control information storage unit
13 policy setting reception unit
14 transmission control information selection unit
15 control information transmission unit
16 control information reception unit
17 reception control information selection unit
20 switch
30 external management apparatus
101 control unit
102 policy storage unit
103 control information exchange unit
200 communication node

What is claimed is:

1. A control apparatus comprising:
a control unit that controls a network in its charge, by setting control information in communication node(s) to be controlled;
a policy storage unit that holds a policy or policies for selecting, from among said control information, control information to be transmitted to another control apparatus; and
a control information exchange unit that transmits, to said other control apparatus, control information selected by referring to said policy.

2. The control apparatus according to claim 1, wherein
a communication node that is to be controlled by the apparatus itself and a communication node that is to be controlled by said other control apparatus are connected, and
a selection is made of control information to implement communication between equipment connected to the communication node that is to be controlled by the apparatus itself, in accordance with said policy.

3. The control apparatus according to claim 1, wherein
a communication node that is to be controlled by the apparatus itself and a communication node that is to be controlled by said other control apparatus are connected, and
a selection is made of control information to drop packet(s) from equipment connected to the communication node that is to be controlled by the apparatus itself, in accordance with said policy.

4. The control apparatus according to claim 1, further comprising: a control information storage unit that stores said control information, wherein
said control information exchange unit selects control information conforming to said policy from said control information storage unit, at prescribed time intervals, and transmits to said other control apparatus.

5. The control apparatus according to claim 4, wherein with control information recorded in said control information storage unit in a past prescribed time-period as a target, among said control information stored in said control information storage unit, said control information exchange unit selects control information to be transmitted to said other control apparatus.

6. The control apparatus according to claim 4, wherein
said policy storage unit holds a reception policy for selecting control information to be stored in said control information storage unit, among control information received from said other control apparatus, and
said control information exchange unit refers to said reception policy to select control information received from said other control apparatus, to be stored in said control information storage unit.

7. The control apparatus according to claim 1, wherein a Border Gateway Protocol Version 4 (BGP4) is used as a protocol for transmitting said control information.

8. A communication system comprising:
a first control apparatus that comprises:
a control unit that controls a network in its charge, by setting control information in communication node(s) to be controlled,
a policy storage unit that holds a policy for selecting, from among said control information, control information to be transmitted to a second control apparatus, and
a control information exchange unit that transmits, to said second control apparatus, control information selected by referring to said policy; and
a second control apparatus that creates control information to be set in communication node(s) to be controlled, by using control information received from said first control apparatus.

9. The communication system according to claim 8, wherein
a communication node that is to be controlled by said first control apparatus and a communication node to be controlled by said second control apparatus are connected, and
said first control apparatus selects control information to implement communication between equipment connected to a communication node that is to be controlled by the apparatus itself, in accordance with said policy.

10. The communication system according to claim 8, wherein
a communication node that is to be controlled by said first apparatus and a communication node that is to be controlled by said second control apparatus are connected, and
said first control apparatus selects control information to drop packet(s) from equipment connected to a communication node that is to be controlled by the apparatus itself, in accordance with said policy.

11. The communication system according to claim 8, wherein
said first control apparatus further comprises a control information storage unit that stores said control information, and
said control information exchange unit selects control information conforming to said policy from said control information storage unit at prescribed time intervals, and transmits to said second control apparatus.

12. The communication system according to claim 11, wherein, with control information recorded in said control information storage unit in a past prescribed time-period as a target, among control information stored in said control information storage unit, said control information exchange unit selects control information to be transmitted to said second control apparatus.

13. The communication system according to claim 11, wherein
said policy storage unit holds a reception policy for selecting control information to be stored in said control information storage unit among control information received from said second control apparatus, and
said control information exchange unit refers to said reception policy to select control information received from said second control apparatus, to be stored in said control information storage unit.

14. The communication system according to claim 8, wherein a Border Gateway Protocol Version 4 (BGP4) is used as a protocol for transmitting said control information.

15. A method of transmitting control information, wherein
a control apparatus comprising a control unit that controls a network in its charge, by setting control information in communication node(s) to be controlled, and a policy storage unit that holds a policy for selecting, among said control information, control information to be transmitted to another control apparatus, performs transmitting control information, the method comprising:
selecting control information to be transmitted to said other control apparatus by referring to said policy, and
transmitting, to said other control apparatus, said selected control information.

16. A non-transitory computer-readable recording medium storing thereon a program executed on a computer comprising
a control unit that controls a network in its charge, by setting control information in communication node(s) to be controlled, and a policy storage unit that holds a policy for selecting, among said control information, control information to be transmitted to another control apparatus, the program executing
a process of selecting control information to be transmitted to said other control apparatus by referring to said policy, and
a process of transmitting, to said other control apparatus, said selected control information.

17. The control apparatus according to claim 2, wherein
a communication node that is to be controlled by the apparatus itself and a communication node that is to be controlled by said other control apparatus are connected, and
a selection is made of control information to drop packet(s) from equipment connected to the communication node that is to be controlled by the apparatus itself, in accordance with said policy.

18. The control apparatus according to claim 2, further comprising: a control information storage unit that stores said control information, wherein
said control information exchange unit selects control information conforming to said policy from said control information storage unit, at prescribed time intervals, and transmits to said other control apparatus.

19. The control apparatus according to claim 3, further comprising: a control information storage unit that stores said control information, wherein
said control information exchange unit selects control information conforming to said policy from said control information storage unit, at prescribed time intervals, and transmits to said other control apparatus.

20. The control apparatus according to claim 5, wherein
said policy storage unit holds a reception policy for selecting control information to be stored in said control information storage unit, among control information received from said other control apparatus, and
said control information exchange unit refers to said reception policy to select control information received from said other control apparatus, to be stored in said control information storage unit.
